(19) United States
(12) Patent Application Publication
(10) Pub. No.: US 2018/0088201 A1
(43) Pub. Date: Mar. 29, 2018

(54) RADIO-WAVE ARRIVAL-DIRECTION ESTIMATION DEVICE AND RADIO-WAVE ARRIVAL-DIRECTION ESTIMATION METHOD

(71) Applicant: FUJITSU LIMITED, Kawasaki-shi (JP)

(72) Inventor: Shunsuke FUJIO, Kawasaki (JP)

(73) Assignee: FUJITSU LIMITED, Kawasaki-shi (JP)

(21) Appl. No.: 15/651,809

(22) Filed: Jul. 17, 2017

(30) Foreign Application Priority Data
Sep. 27, 2016 (JP) 2016-188805

(51) Int. Cl. G01S 3/32; G01S 3/48

(52) U.S. Cl. CPC G01S 3/32; G01S 3/48

(57) ABSTRACT

A radio-wave arrival-direction estimation device includes: a processor configured to: determine a plurality of amplitude distributions to be used for signal receptions by respective antennas in a plurality of antenna elements that constitute a plurality of antennas; switch among the amplitude distributions determined for each of the signal receptions; and estimate a radio-wave arrival direction of a reception signal based on a correlation coefficient of the reception signal between different antennas and the amplitude distributions switched.

### CROSS-REFERENCE TO RELATED APPLICATION

This application is based upon and claims the benefit of priority of the prior Japanese Patent Application No. 2016-188805, filed on Sep. 27, 2016, the entire contents of which are incorporated herein by reference.

### FIELD

The embodiments discussed herein are related to a radio-wave arrival-direction estimation device and a radio-wave arrival-direction estimation method.

### BACKGROUND

In recent years, with an increase in the speed of wireless communication, a technology of beam forming in multi-elements is becoming important to compensate propagation loss, particularly, in a high frequency range. As a configuration to realize beam forming (BF), a hybrid BF configuration in which a plurality of phased arrays are connected to one digital-signal processing circuit via individual D/A (Digital/Analog) converters and A/D (Analog/Digital) converters, respectively, is attracting attention. The hybrid BF configuration can achieve both beam control on a plurality of users by digital signal processing and beam control with low power consumption using the phased arrays. It is important to accurately estimate a direction (radio-wave arrival direction) in which a communication partner is located to obtain a high gain using the beam control. As measures for such estimation, there are two methods including a method of using phase information of a signal and a method of not using phase information of a signal.

One example of the former method of using phase information is a method in which the respective phased arrays form beams to receive signals and estimate a radio-wave arrival direction based on a phase difference between received signals depending on the radio-wave arrival direction. For example, “A hybrid adaptive antenna array” by X. Huang et al. (IEEE Transactions on Wireless Communications (Volume: 9, Issue: 5, pp. 1770-1779, May 2010)) discloses a technique of forming beams with phased arrays to be directed in certain directions to estimate an arrival direction based on received signals, updating the beam directions with the estimated direction, and thereafter estimating again the arrival direction. With this technique, estimation of the arrival direction can be performed accurately by repeating estimation of the arrival direction and update of the beam directions.

One example of the latter method of not using phase information is a method in which a base station transmits beams having directivities in different directions sequentially one direction by one direction while changing transmission times, and estimates the direction of a terminal that has received the beams based on reception quality information of the respective beams reported by the terminal. For example, International Publication No. WO 2014/054908 discloses a technique of performing this beam search at two steps. In this technique, the base station roughly estimates a range in which the terminal is located using thick beams at the first step and performs a detailed search only for the range estimated at the first step at the subsequent second step.
Patent Document 1: International Publication Pamphlet No. WO 2014/054908

Non Patent Document 1: X. Huang et al., “A hybrid adaptive antenna array” IEEE Transactions on Wireless Communications (Volume: 9, Issue: 5, pp. 1770-1779, May 2010)

However, both the methods described above have problems described below. First, in the former method of using phase information, a phase difference between signals received respectively with the phased arrays is important during estimation of the radio-wave arrival direction and thus a calibration mechanism to perform phase synchronization between the phased arrays is used. If a phase difference occurs between circuits in the respective phased arrays due to a reason such as path differences of the respective circuits or insufficient accuracy in phase synchronization of local signals, a phase fluctuation depending on the radio-wave arrival direction and a phase fluctuation due to the circuits are mixed. This hinders the base station from estimating the radio-wave arrival direction accurately.

In the latter method of not using phase information, the base station repeats transmissions and receptions of many beams while changing the times to enhance the resolution of direction estimation. As a result, it takes a long time to estimate the arrival direction of the radio-wave from the terminal.

### SUMMARY

According to an aspect of the embodiments, a radio-wave arrival-direction estimation device includes: a processor configured to: determine a plurality of amplitude distributions to be used for signal receptions by respective antennas in a plurality of antenna elements that constitute a plurality of antennas; switch among the amplitude distributions determined for each of the signal receptions; and estimate a radio-wave arrival direction of a reception signal based on a correlation coefficient of the reception signal between different antennas and the amplitude distributions switched.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a wireless communication system;

FIG. 2 is a diagram illustrating an example of a combination of amplitude distributions in a first embodiment;

FIG. 3 is an explanatory diagram of the principle of radio-wave arrival-direction estimation according to the first embodiment;

FIG. 4 is a diagram illustrating a functional configuration of a base station according to the first embodiment;

FIG. 5 is a diagram illustrating a hardware configuration of the base station according to the first embodiment;

FIG. 6 is a flowchart for explaining an operation of the base station according to the first embodiment;

FIG. 7 is an explanatory diagram of a relation between reception beam forming gains and resolutions of radio-wave arrival-direction estimation according to the first embodiment;

FIG. 8 is a diagram illustrating a functional configuration of a base station according to a second embodiment;

FIG. 9 is a flowchart for explaining an operation of the base station according to the second embodiment;

FIG. 10 is a flowchart for explaining an operation of a base station according to a third embodiment; and

FIG. 11 is a diagram illustrating an example of combinations of amplitude distributions in the third embodiment.

### DESCRIPTION OF EMBODIMENTS

Preferred embodiments will be explained with reference to accompanying drawings. The radio-wave arrival-direction estimation device and the radio-wave arrival-direction estimation method disclosed in the present application are not limited to the embodiments.

### [a] First Embodiment

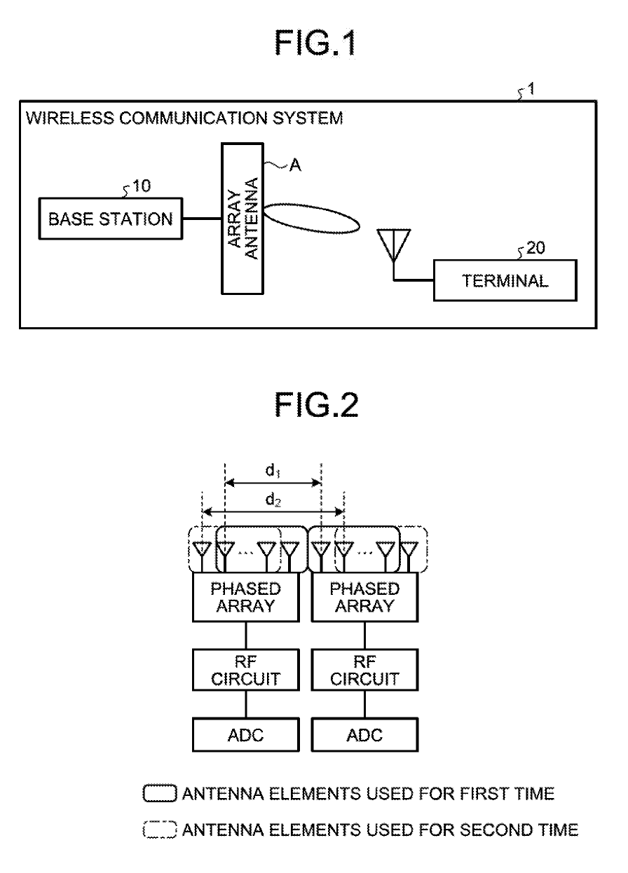

FIG. 1 is a diagram illustrating a wireless communication system 1. As illustrated in FIG. 1, the wireless communication system 1 has a base station 10 having an array antenna A, and a terminal 20. In the wireless communication system 1, the base station 10 has N phased arrays (N is an integer equal to or larger than 2) in which there is a phase difference occurring in circuits between the phased arrays, and estimates a radio-wave arrival direction based on results of two signal receptions. The array antenna A is a uniform linear array antenna in which an element interval is d [meters] and the number of elements in each of the phased arrays is M (M is an integer equal to or larger than 2).

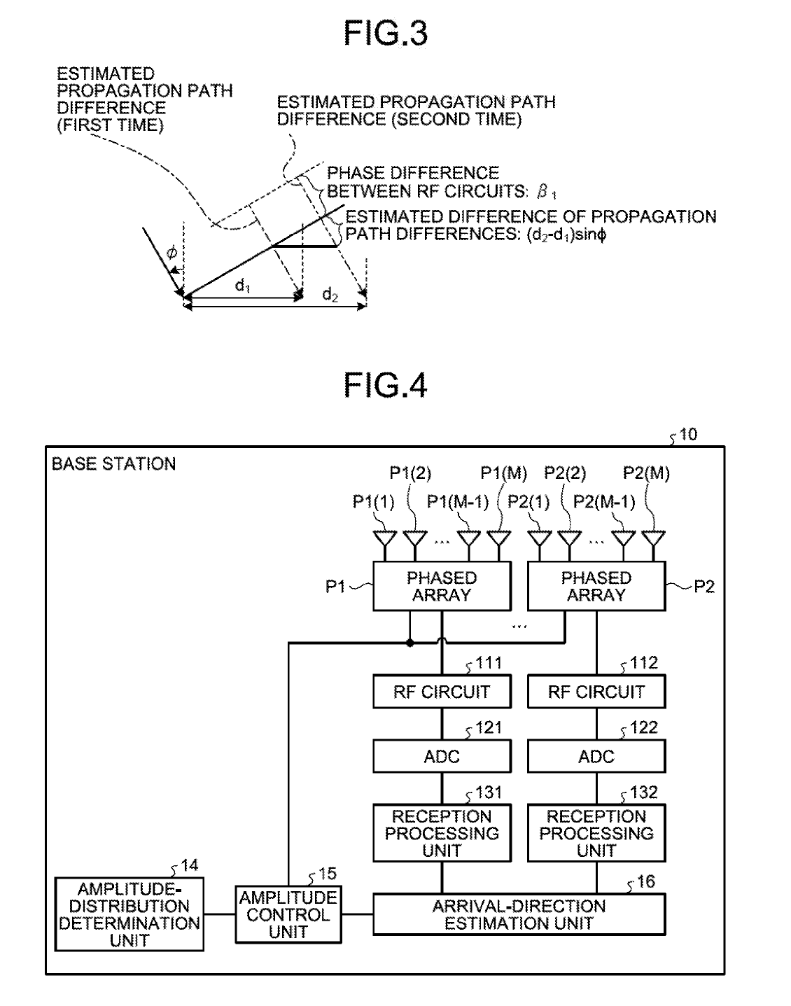

Prior to descriptions of a configuration and an operation of the base station 10 according to the present embodiment, the principle of radio-wave arrival-direction estimation as the premise is described with reference to FIG. 2. Each time a signal is received, the base station 10 changes the interval of subarrays forming a beam to eliminate a phase difference depending on circuits, and extracts a phase difference depending on a radio-wave arrival direction. FIG. 2 is a diagram illustrating an example of a combination of amplitude distributions in the first embodiment. As illustrated in FIG. 2, a case where positions of used antenna elements are changed at a first reception and a second reception is assumed. FIG. 3 is an explanatory diagram of the principle of radio-wave arrival-direction estimation according to the first embodiment. A propagation path difference estimated from a phase difference in signals at each of the first and second receptions is a value obtained by combining influences of an actual propagation path difference and a phase difference between RF (Radio Frequency) circuits as illustrated in FIG. 3. When a difference between the phase differences at the two receptions is calculated, the influence of a phase difference β₁ between the RF circuits is eliminated because common RF circuits are used at the two receptions. That is, a value depending only on the actual radio-wave arrival direction and a difference between subarray intervals at the two receptions is obtained. Because a difference d₂−d₁ between the subarray intervals at the two receptions is known, the base station 10 can estimate the radio-wave arrival direction based on a difference (d₂−d₁)sin φ between estimated propagation path differences.

The configuration of the base station 10 according to the present embodiment is described first. FIG. 4 is a diagram illustrating a functional configuration of the base station 10 according to the first embodiment. As illustrated in FIG. 4, the base station 10 has phased arrays P1 and P2, RF circuits 111 and 112, ADCs (Analog to Digital Converters) 121 and 122, reception processing units 131 and 132, an amplitude-distribution determination unit 14, an amplitude control unit 15, and an arrival-direction estimation unit 16. These constituent elements are connected to enable signals and packets to be input or output in one direction or both directions. While only two phased arrays P1 and P2 (a case of N=2) are illustrated as an example in FIG. 4 to simplify the descriptions, three or more phased arrays can be provided as described above.

The phased array P1 controls phases and amplitudes of signals received by antenna elements P1(1), P1(2), . . . , P1(M−1), and P1(M) and synthesizes the signals to output a synthesized signal to the RF circuit 111 located at the subsequent stage. The RF circuit 111 down-converts the input signal. The ADC 121 converts the input analog signal into a digital signal. The reception processing unit 131 performs channel estimation processing, demodulation, and decoding processing to the input digital signal. Similarly, the phased array P2 controls phases and amplitudes of signals received by antenna elements P2(1), P2(2), . . . , P2(M−1), and P2(M) and synthesizes the signals to output a synthesized signal to the RF circuit 112 located at the subsequent stage. The RF circuit 112 down-converts the input signal. The ADC 122 converts the input analog signal into a digital signal. The reception processing unit 132 performs channel estimation processing, demodulation, and decoding processing to the input digital signal.

The amplitude-distribution determination unit 14 determines combinations of amplitude distributions of respective antenna elements from among all the antenna elements P1(1) to P1(M) included in the phased array P1. Similarly, the amplitude-distribution determination unit 14 determines combinations of amplitude distributions of respective antenna elements from among all the antenna elements P2(1) to P2(M) included in the phased array P2. The amplitude control unit 15 switches among the amplitude distributions determined by the amplitude-distribution determination unit 14 to control amplitude gain values of the phased arrays P1 and P2. The arrival-direction estimation unit 16 estimates a radio-wave arrival direction of a signal transmitted from, for example, the terminal 20 based on the amplitude distributions used by the amplitude control unit 15 and the reception signals processed by the reception processing units 131 and 132.

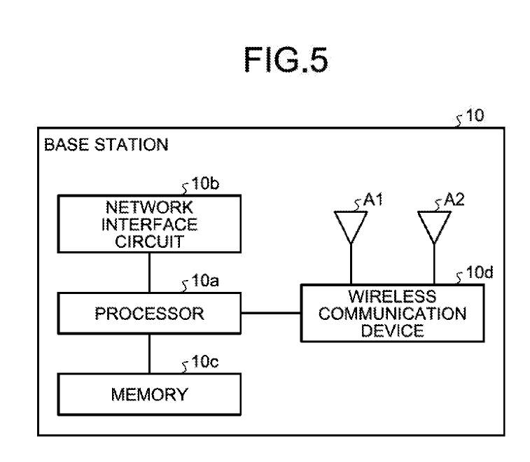

A hardware configuration of the base station 10 is described next. FIG. 5 is a diagram illustrating a hardware configuration of the base station 10 according to the first embodiment. As illustrated in FIG. 5, a processor 10a, a network interface circuit 10b, a memory 10c, and a wireless communication device 10d having array antennas A1 and A2 are connected in the base station 10 to enable various signals and data to be input or output via a bus. The processor 10a is, for example, a CPU (Central Processing Unit) or a DSP (Digital Signal Processor). The memory 10c includes, for example, a non-volatile storage such as a ROM (Read Only Memory), a flash memory, or an HD (Hard Disk), as well as a RAM (Random Access Memory) such as an SDRAM (Synchronous Dynamic RAM).

A correspondence relation between functional constituent elements and hardware constituent element is described next. Among the functional constituent elements of the base station 10 illustrated in FIG. 4, the phased arrays P1 and P2, the RF circuits 111 and 112, the ADCs (Analog to Digital Converters) 121 and 122, and the reception processing units 131 and 132 are realized by the wireless communication device 10d as hardware. The amplitude-distribution determination unit 14, the amplitude control unit 15, and the arrival-direction estimation unit 16 are realized by the processor 10a and the wireless communication device 10d as hardware.

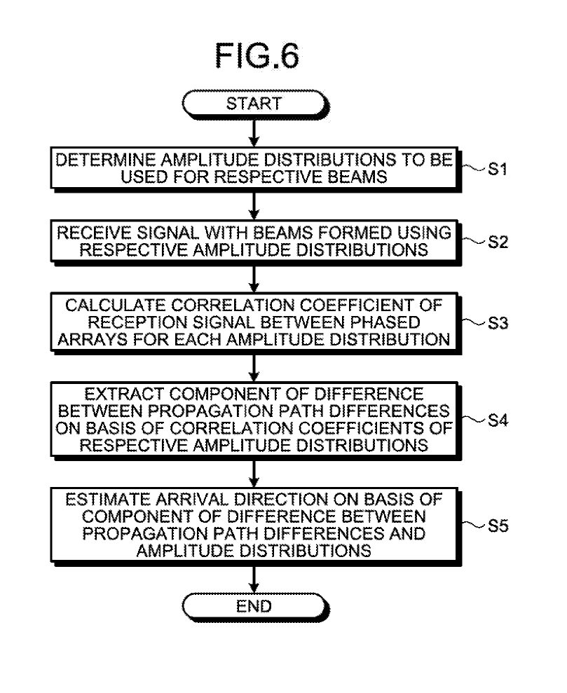

An operation of the base station 10 is described next. FIG. 6 is a flowchart for explaining an operation of the base station 10 according to the first embodiment.

First, at Step S1, the amplitude-distribution determination unit 14 determines amplitude determinations to be used for formation of respective beams. In the present embodiment, a case where the amplitude-distribution determination unit 14 determines two amplitude distributions to be used during receptions of a signal is cited as an example. As the amplitude distributions, distributions in which the amplitudes of signals received by some of the antenna elements are set to 0 (zero) to enable a variable number of antenna elements to be used are cited as an example. In a mode of the present embodiment, the amplitudes do not always need to be zero and an identical effect is achieved when the amplitudes have a sufficiently small value.

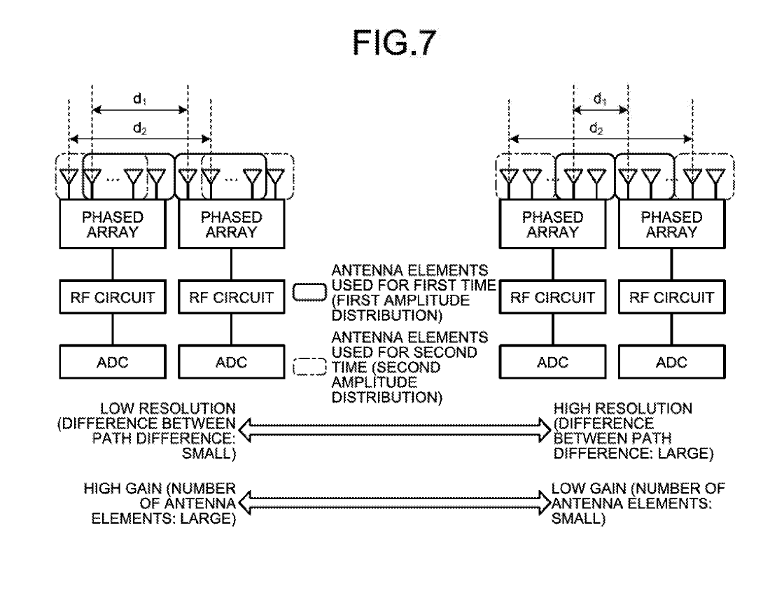

FIG. 7 is an explanatory diagram of a relation between reception beam forming gains and resolutions of radio-wave arrival-direction estimation according to the present embodiment. As illustrated in FIG. 7, the number of antenna elements to be used can be determined depending on a demanded reception beam forming gain and a demanded resolution of the radio-wave arrival-direction estimation. For example, as illustrated on the right side in FIG. 7, as the difference d₂−d₁ between the subarray intervals is larger, even a small difference in the radio-wave arrival direction appears as a large phase fluctuation. Therefore, the amplitude-distribution determination unit 14 can improve the resolution of the radio-wave arrival-direction estimation by enlarging the difference d₂−d₁ between the subarray intervals using a small number of antenna elements (for example, two antenna elements).

Meanwhile, when the number of antenna elements to be used is small, the reception beam forming gain is reduced although the resolution is improved. Accordingly, due to a reduction in reception power associated therewith, the estimation accuracy of the phase difference may be reduced. Therefore, the amplitude-distribution determination unit 14 determines the number of antenna elements to be used for signal receptions from the terminal 20 to be an appropriate value depending on a demanded reception beam forming gain (the gain of the reception signals described above) and a demanded resolution of the radio-wave arrival-direction estimation. This enables adjustment between the reception power and the direction estimation accuracy, and can perform estimation of the radio-wave arrival direction with high accuracy while securing requested reception power.

For example, when high reception power is expected while the reception beam forming gain is low as in a case where the terminal 20 is located close to the base station 10, the amplitude-distribution determination unit 14 determines amplitude distributions using a small number of antenna elements to prioritize and improve the resolution as much as possible. Conversely, when sufficient reception power to be used for estimation of a phase difference is not obtained as in a case where the terminal 20 is located far away from the base station 10, the amplitude-distribution determination unit 14 determines amplitude distributions using a large number of antenna elements to prioritize and improve the gain as much as possible.

However, as illustrated in FIG. 7, it is desirable that the numbers of used antenna elements in the same phased array are fixed in respective use times (signal receptions) in view of the amount of computing. If the numbers of antenna elements change, the phases of formed beams change and thus estimation of the radio-wave arrival direction needs to be performed considering also influences of the changes, which increases the amount of computing. Therefore, in the present embodiment, the numbers of antenna elements used in the amplitude-distribution determination unit 14 of the base station 10 are equal regardless of the number of times of use and combinations of amplitude distributions in which only the positions of used antenna elements are different are used.

Referring back to FIG. 6, at subsequent Step S2, the amplitude control unit 15 controls the phased arrays P1 and P2 based on the amplitude distributions determined by the amplitude-distribution determination unit 14 to form beams using the amplitude distributions and receive a signal transmitted by the terminal 20. The phased arrays P1 and P2 receive a signal transmitted by the terminal 20 with the beams, respectively. A reception signal y_{n,k} received at that time can be represented by the following expression (1). In the following expression (1), a variable representing a phase fluctuation in the RF circuit of a phased array n is αₙ, a row vector of a weight of the phased array n at the time of kth beam formation is w_{n,k}, a column vector of a propagation channel for each antenna element is hₙ, and a transmission signal of the terminal 20 is s(t). In the following expression (1), noise is ignored and the phase fluctuation and the channel in the RF circuit are assumed to be fixed during measurement.

y_{n,k}=aₙw_{n,k}hₙs(t) (1)

When an incoming wave is assumed to be one wave as in the present embodiment, the channel can be represented by the following expression (2).

$${h}_{n} = [ 1 , exp ( j \frac{2 π}{λ} \cdot 1 \cdot d sin φ ) , … , {exp ( j \frac{2 π}{λ} \cdot ( M - 1 ) \cdot d sin φ ) ]}^{T} exp ( j \frac{2 π}{λ} \cdot ( n - 1 ) M \cdot d sin φ ) \qquad ( 2 )$$

When a beam direction of the phased array n at the time of the kth beam formation is θ_{n,k}, the number of used antenna elements is M_{n,k}, and an index indicating the positions of antenna elements to be used first (located at the head) is i_{n,k}, and an ith element of a weight vector can be represented by the following expression (3).

$${w}_{n , k , i} = \{ \begin{matrix}exp ( - j \frac{2 π}{λ} \cdot ( i - {i}_{n , k} ) \cdot d sin {θ}_{n , k} ) , {i}_{n , k} \leq i \leq {i}_{n , k} + {M}_{n , k} - 1 \\ 0 , otherwise\end{matrix} \qquad ( 3 )$$

Assuming that the number of antenna elements and the beam direction are not changed in the expression (3), the following expression (4) is assumed.

θ_{n,k}=θₙ,M_{n,k}=Mₙ (4)

When an approximate direction of the terminal 20 is previously known, the base station 10 can direct the beam directions of the respective phased arrays n to that direction. For example, the base station 10 can estimate the approximate direction by previously performing a rough beam search with a small number of beams. When the direction is not known at all, the base station 10 directs the beams to an arbitrary direction in a coverage area to perform signal receptions.

At subsequent Step S3, the arrival-direction estimation unit 16 calculates a correlation coefficient of a reception signal between the phased arrays P1 and P2 for each of the amplitude distributions. That is, the arrival-direction estimation unit 16 calculates a correlation coefficient r_{k,n,l} between a reception signal of the phased array n and a reception signal of a phased array 1 with respect to signals received with the respective amplitude distributions. When it is assumed that average transmission power is standardized to 1, a complex conjugate of a variable x is x*, and a conjugate transpose of a vector “a” is a^{H}, the correlation coefficient r_{k,n,l} can be represented by the following expression (5).

r_{k,n,l}=E└y_{n,k}y*_{l,k}┘=aₙw_{n,k}hₙE└s(t)s*(t)┘hᵢ^{H}w_{l,k}^{H}a*ₗ=(aₙaₗ*)w_{n,k}hₙhₗ^{H}w_{l,k}^{H} (5)

When a known signal such as a pilot signal is transmitted, the arrival-direction estimation unit 16 can calculate a correlation coefficient with the phase difference between the RF circuits eliminated based on the estimation result of the channels for the reception signals described above. Because signals at the time of channel estimation are signals synchronized in the phased arrays n and 1 and including phase fluctuations having occurred in the RF circuits, the channel estimation value can be represented by the following expression (6).

ĥ_{n,k}=aₙw_{n,k}hₙ (6)

Therefore, the correlation coefficient of a reception signal between the phased arrays n and 1 can be estimated from the following expression (7).

r_{k,n,l}=ĥ_{n,k}ĥ_{l,k}* (7)

Thereafter, the arrival-direction estimation unit 16 of the base station 10 estimates the radio-wave arrival direction based on the correlation coefficient and the amplitude distributions. That is, the arrival-direction estimation unit 16 estimates the propagation path difference based on the calculated correlation coefficient, and calculates the radio-wave arrival direction using information of the difference between the subarray intervals calculated from the amplitude distributions.

First, at Step S4, the arrival-direction estimation unit 16 extracts a component of a difference between the propagation path differences based on the correlation coefficients of the respective amplitude distributions described above. As described above, the phase differences between the RF circuits are common in receptions in the respective amplitude distributions. Therefore, an influence of a change in the amplitude distributions, that is, a component z_{n,l} depending on a difference between the propagation path differences can be extracted from the following expression (8).

z_{n,l}=r_{2,n,l}r_{1,n,l}* (8)

Because the phase of a complex value corresponds to the difference between the propagation path differences, a phase φ_{n,1} can be calculated by the following expression (9) when the phase φ_{n,1} is calculated using a function arg(x) that enables to calculate the phase of a complex number x.

ψ_{n,l}=arg(z_{n,l)} (9)

When the numbers of antenna elements and the beam directions for respective reception signals are the same in each of the phased arrays, the phase φ_{n,1} becomes a value proportional to the path difference as illustrated in FIG. 3 and is represented by the following expression (10) when d_{n,l,k}=(i_{n,k}−i_{l,k}+(n−1)M)d. In the expression, p is an appropriate integer added to enable the arg function to output the same value even when the phase is shifted by 2π.

$${ψ}_{n , i} = \frac{2 π}{λ} ( {d}_{n , l , 2} - {d}_{n , l , 1} ) sin φ + 2 π p \qquad ( 10 )$$

At Step S5, the arrival-direction estimation unit 16 performs estimation of the radio-wave arrival direction based on the component of the difference between the propagation path differences and the amplitude distributions by the following expression (11).

$$φ = a sin \{ ( \frac{{ψ}_{n , l}}{2 π} - p ) \frac{λ}{{d}_{n , l , 2} - {d}_{n , l , 1}} \} \qquad ( 11 )$$

In this expression, p is provided to cause values in an a sin function to fall within the domain of definition (not smaller than −1 and not larger than 1). When a difference d_{n,l,2}−d_{n,l,1} of the subarray intervals is larger than a half wavelength, p described above can take plural values and thus the direction is not obtained uniquely. In this case, the arrival-direction estimation unit 16 can, for example, estimate an estimation direction closest to the beam direction as the radio-wave arrival direction regarding that an incoming wave from vicinity of a direction in which the beam is directed is highly likely to be an actual incoming wave. When the base station 10 has three or more phased arrays, the arrival-direction estimation unit 16 can perform weighted averaging processing to the radio-wave arrival direction estimated for each of the phased arrays depending on the reception power of each of the phased arrays, and recalculate the radio-wave arrival direction. This enables estimation of the radio-wave arrival direction with higher accuracy.

As described above, the base station 10 has the amplitude-distribution determination unit 14, the amplitude control unit 15, and the arrival-direction estimation unit 16. The amplitude-distribution determination unit 14 determines plural patterns of amplitude distributions (combinations of antenna elements, for example) to be used in respective antennas among the antenna elements P1(1) to P1(M) and P2(1) to P2(M) constituting a plurality of antennas (the phased arrays P1 and P2, for example) for receptions of a signal transmitted by the terminal 20. The amplitude control unit 15 switches among the plural patterns of the amplitude distributions determined by the amplitude-distribution determination unit 14 with respect to each of the signal receptions. Based on a correlation coefficient of a reception signal between different antennas and a combination of the amplitude distributions switched by the amplitude control unit 15, the arrival-direction estimation unit 16 estimates the radio-wave arrival direction of the reception signal. In other words, the base station 10 switches among a plurality of beams in which amplitude distributions of the respective antenna elements are different from each other to receive a signal with the phased arrays P1 and P2, and estimates the radio-wave arrival direction based on the correlation coefficient of the reception signal between the different phased arrays P1 and P2 and the used amplitude distributions. Therefore, the base station 10 can estimate the radio-wave arrival direction with a small number of receptions, with high accuracy, and in a short time without the need to include a phase-difference calibration mechanism for performing phase synchronization between respective phased arrays.

While a method of estimating the direction of one incoming wave by switching between two amplitude distributions has been described (see FIG. 7) in the present embodiment, estimation of directions of a plurality of incoming waves can be performed by switching among three or more amplitude distributions in which the subarray intervals at the time of beam forming are different from each other. Furthermore, the configuration in which the antenna elements P1(1) to P1(M) and P2(1) to P2(M) are arrayed in one dimension (linearly) has been described (see FIG. 4) as the configuration of the array antenna A in the present embodiment. However, the array antenna A is not limited to this configuration and can be a planar antenna in which antenna elements are arrayed in a plane. In this case, the arrival-direction estimation unit 16 of the base station 10 performs the processes at Steps S3 to S5 described above with respect to each of a pair of beams where the horizontal subarray intervals are changed, and a pair of beams where the vertical subarray intervals are changed. This enables the radio-wave arrival direction to be estimated individually for each of directions (the horizontal direction and the vertical direction).

In the base station 10, the amplitude control unit 15 can control the number of used antenna elements by setting the amplitudes of signals received by some of the antenna elements P1(1) to P1(M) and P2(1) to P2(M) to zero. This enables the base station 10 to easily and promptly change amplitude distributions (combinations of antenna elements) to be used in the phased arrays P1 and P2 for receptions of a signal transmitted by the terminal 20.

In the base station 10, the amplitude-distribution determination unit 14 can alternatively determine the amplitude distributions in which the numbers of used antenna elements are the same and the positions of the used antenna elements are different with respect to each of the phased arrays P1 and P2. Accordingly, the numbers of used antenna elements are fixed in respective signal receptions and thus the phases of formed beams are also fixed, so that the base station 10 can estimate the radio-wave arrival direction without considering phase fluctuations. As a result, an increase in the amount of computing during estimation of the radio-wave arrival direction is suppressed.

In the base station 10, the amplitude-distribution determination unit 14 can determine the number of antenna elements used for the signal receptions depending on a demanded gain of the reception signal and a demanded resolution of the estimation of the radio-wave arrival direction. This enables adjustment between the reception power and the direction estimation accuracy and estimation of the radio-wave arrival direction can be performed with high accuracy while securing requested reception power.

### [b] Second Embodiment

A second embodiment is described next. A base station according to the second embodiment is different from the base station according to the first embodiment in further estimating a phase difference occurring between RF circuits of different phased arrays based on information of the radio-wave arrival direction estimated by the method described in the first embodiment.

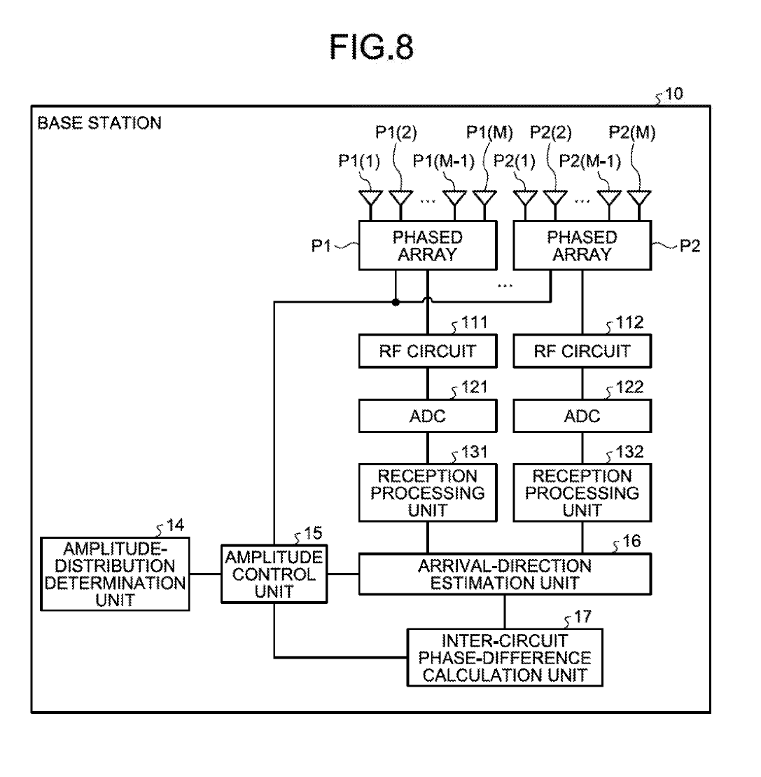

A configuration of the base station according to the second embodiment is identical to that of the base station in the first embodiment illustrated in FIG. 4 except for additionally including an inter-circuit phase-difference calculation unit 17. FIG. 8 is a diagram illustrating a functional configuration of the base station 10 according to the second embodiment. As illustrated in FIG. 8, in the second embodiment, constituent elements common to those in the first embodiment are denoted by like reference signs, and detailed explanations thereof are omitted.

The inter-circuit phase-difference calculation unit 17 calculates a phase difference between the RF circuits 111 and 112 based on information of the correlation coefficient and the radio-wave arrival direction calculated by the arrival-direction estimation unit 16 and the amplitude distributions notified from the amplitude control unit 15.

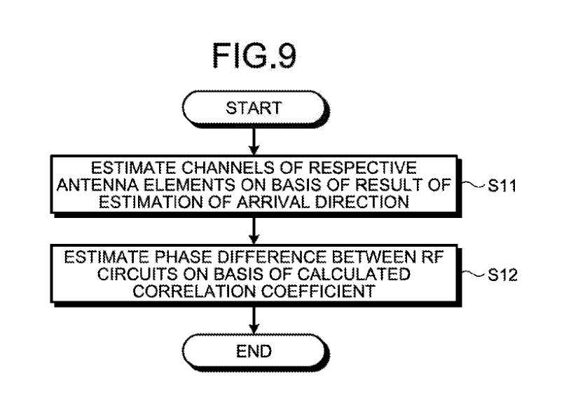

An operation of the base station 10 in the second embodiment is described next focusing on the difference from the first embodiment. FIG. 9 is a flowchart for explaining the operation of the base station 10 according to the second embodiment. First, at Step S11, the inter-circuit phase-difference calculation unit 17 substitutes the radio-wave arrival direction estimated at Step S5 described above (see FIG. 6) into the expression (1) described above, thereby estimating channels of the respective antenna elements based on the estimation result of the radio-wave arrival direction. At subsequent Step S12, the inter-circuit phase-difference calculation unit 17 estimates a phase difference between the RF circuits 111 and 112 based on the correlation coefficient calculated at Step S3 described above (see FIG. 6). Specifically, the inter-circuit phase-difference calculation unit 17 calculates the phase difference by the following expression (12) using the calculated correlation coefficient r_{k,n,l}, column vectors hₙ and hₗ of the estimated channels, and row vectors w_{n,k} and w_{l,k} of weights of phased arrays n and l.

$$arg ( {a}_{n} ) - arg ( {a}_{l} ) = arg ( \frac{{r}_{k , n , l}}{{w}_{n , k} {h}_{n} {h}_{l}^{H} {w}_{l , k}^{H}} ) \qquad ( 12 )$$

As described above, the base station 10 according to the second embodiment further has the inter-circuit phase-difference calculation unit 17 that estimates a phase difference depending on the RF circuits between the phased arrays P1 and P2 based on the radio-wave arrival direction estimated by the arrival-direction estimation unit 16, and the correlation coefficient of the reception signal described above. Therefore, the base station 10 can estimate the phase difference occurring between the RF circuits as well as the radio-wave arrival direction with high accuracy and in a short time.

### [c] Third Embodiment

A third embodiment is described next. A base station according to the third embodiment is different from the base station according to the first embodiment in having three or more phased arrays and averaging calculation results of a correlation coefficient between phased arrays. Accordingly, the base station according to the third embodiment can suppress noise occurring in the difference of the propagation path differences and further improve the estimation accuracy of the radio-wave arrival direction. Specifically, between phased arrays in which the differences of the propagation path differences are different, expected values (ideal calculation results with no influence of noise) of components depending on the differences of the propagation path differences are also different. Accordingly, the base station groups a plurality of phased arrays to be used for suppression of noise at the step of determining the amplitude distributions, and uses amplitude distributions in which the differences of the propagation path differences between the phased arrays of each group are fixed. This can achieve suppression of noise after matching the expected values.

A configuration of the base station according to the third embodiment is identical to that of the base station according to the first embodiment illustrated in FIG. 4. Therefore, in the third embodiment, constituent elements common to those in the first embodiment are denoted by like reference signs, and detailed explanations thereof are omitted.

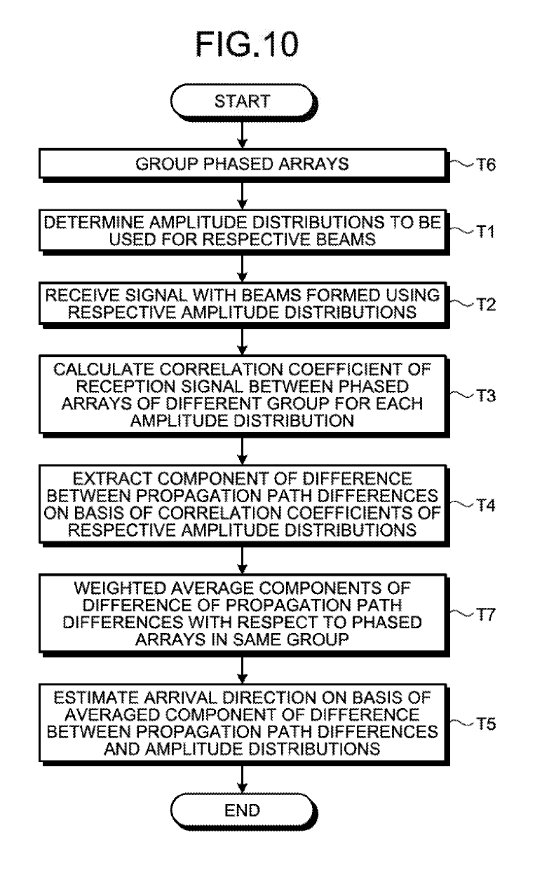

An operation of the base station 10 in the third embodiment is described next focusing on the difference from the first embodiment. FIG. 10 is a flowchart for explaining the operation of the base station 10 according to the third embodiment. Because FIG. 10 contains identical processes to those in FIG. 6 that has been referred to for the descriptions of the operation according to the first embodiment, common steps are denoted by reference signs being same at the ends and detailed descriptions thereof are omitted. Specifically, processes at Steps T1 to T5 in FIG. 10 correspond to the processes at Steps S1 to S5 illustrated in FIG. 6, respectively.

First, at Step T6, prior to the determination of the amplitude distributions, the amplitude-distribution determination unit 14 groups phased arrays to divide the phased arrays into two or more groups (subarray groups G1 and G2, for example). At that time, if the numbers of phased arrays included in the respective groups are uneven, the effect of suppressing noise in a group including a smaller number of phased arrays is reduced and noise of that group may exert a dominant influence on the entire estimation accuracy. Therefore, to realize high estimation accuracy of the radio-wave arrival direction, it is desirable that the amplitude-distribution determination unit 14 performs grouping in which the numbers of phased arrays in the respective groups are equal.

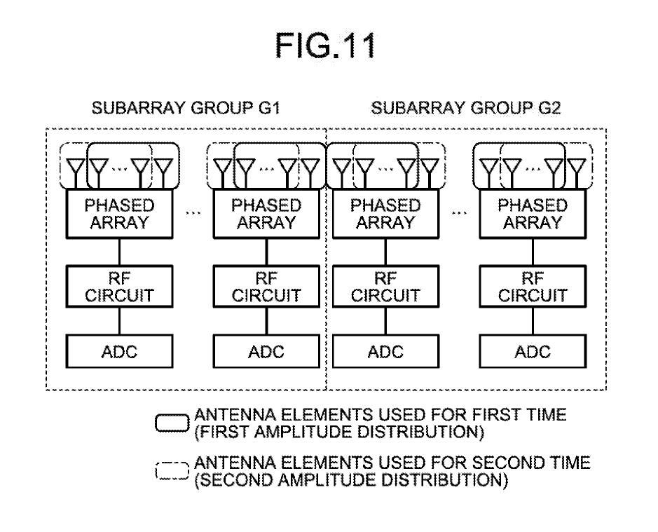

At subsequent Step T1, the amplitude-distribution determination unit 14 determines amplitude distributions to be used for respective beams similarly to Step S1 (see FIG. 6) in the first embodiment. FIG. 11 is a diagram illustrating an example of combinations of amplitude distributions in the third embodiment. As illustrated in FIG. 11, the same number of antenna elements and the same positions of the antenna elements are used in phased arrays in the same group (the subarray group G1, for example). Accordingly, expected values of a component depending on the difference of propagation path differences calculated with phased arrays in a different group (the subarray group G2, for example) become equal among the phased arrays in the same group (the subarray group G1, for example).

Referring back to FIG. 10, at subsequent Step T2, the amplitude control unit 15 receives a signal transmitted by the terminal 20 with the beams formed using the respective amplitude distributions determined at Step T1 described above, similarly to Step S2 (see FIG. 6) in the first embodiment.

At Step T3, the arrival-direction estimation unit 16 calculates a correlation coefficient of the reception signal between phased arrays with respect to the signals received with the respective amplitude distributions determined at Step T1 described above, similarly to Step S3 (see FIG. 6) in the first embodiment. However, there is no difference in the propagation path differences between the phased arrays in the same group and thus the difference in the propagation path differences does not need to be calculated. The arrival-direction estimation unit 16 calculates only a correlation coefficient of the reception signal between the phased arrays of the different subarray groups G1 and G2.

Thereafter, the arrival-direction estimation unit 16 of the base station 10 estimates the radio-wave arrival direction based on the respective correlation coefficients and the amplitude distributions. That is, the arrival-direction estimation unit 16 estimates the propagation path differences based on the calculated correlation coefficients and calculates the radio-wave arrival direction using information of the difference of the subarray intervals calculated from the amplitude distributions.

First, at Step T4, the arrival-direction estimation unit 16 extracts a component z_{n,1} depending on the difference of the propagation path differences based on the correlation coefficients of the respective amplitude distributions similarly to Step S4 (see FIG. 6) in the first embodiment. At subsequent Step T7, for phased arrays in a same group g, the arrival-direction estimation unit 16 calculates, regarding the phased arrays in a same group, a weighted average of components depending on the difference of the propagation path differences, which has been calculated with the phased arrays in another group g′, to suppress noise of the reception signals described above. The weighted average can be calculated, for example, by the following expression (13).

$${\overline{z}}_{g , {g}^{′}} = \frac{1}{{\sum }_{n ∈ {S}_{g}}^{ } {\sum }_{l ∈ {S}_{{g}^{′}}}^{ } {c}_{n , l}} {\sum }_{n ∈ {S}_{g}}^{ } {\sum }_{l ∈ {S}_{{g}^{′}}}^{ } {c}_{n , l} {z}_{n , l} \qquad ( 13 )$$

In this expression (13), S_{g} and S_{g′} are sets of indexes of phased arrays included in the groups g and g′, respectively. Further, c_{n,1} is a weight of the average and, for example, can be defined by the following expression (14) in such a manner that a phased array with larger reception power has a larger weight.

c_{n,l}=|z_{n,l}|² (14)

At Step T5, the arrival-direction estimation unit 16 estimates the radio-wave arrival direction by the following expression (15) based on the phase of a weighted averaged value, similarly to Step S5 (see FIG. 6) in the first embodiment.

$$φ = a sin \{ ( \frac{{\overline{ψ}}_{g , {g}^{′}}}{2 π} - p ) \frac{λ}{{d}_{n , l , 2} - {d}_{n , l , 1}} \} \qquad ( 15 )$$

In this case, the expression (15) meets the following expression (16).

ψ̅_{g,g′}=arg(z̅_{g,g′}) (16)

As described above, in the base station 10 according to the third embodiment, the amplitude-distribution determination unit 14 groups a plurality of phased arrays and determines amplitude distributions in which the numbers of used antenna elements and the positions of the used antenna elements are the same among phased arrays in the same group as amplitude distributions of the corresponding group. The arrival-direction estimation unit 16 estimates the radio-wave arrival direction of the reception signal based on a value obtained by weighted averaging the correlation coefficients between respective phased arrays with respect to the phased arrays in the same group. Accordingly, noise occurring in the difference of the propagation path differences can be suppressed. As a result, estimation of the radio-wave arrival direction with high accuracy can be achieved.

It is not always necessary that the constituent elements of the base station 10 are configured physically as illustrated. That is, specific modes of distribution or integration of the respective devices are not limited to those illustrated and all or some of the devices can be functionally or physically distributed or integrated in an arbitrary unit according to various types of load or status of use. For example, the amplitude-distribution determination unit 14 and the amplitude control unit 15, or the arrival-direction estimation unit 16 and the inter-circuit phase-difference calculation unit 17 can be integrated as one constituent element. In contrast, for example, the arrival-direction estimation unit 16 can be divided into a portion that calculates the correlation coefficient, a portion that extracts the difference of the propagation path differences, and a portion that actually estimates the radio-wave arrival direction. Furthermore, the storage such as the memory 10c can be connected as an external device of the base station 10 via a network or a cable.

In the above descriptions, individual configurations and operations have been described for each of the embodiments. However, the base station 10 according to the respective embodiments can include constituent elements specific to other embodiments. Further, combinations of the respective embodiments are not limited to combinations of two embodiments, and it is also possible to adopt other arbitrary modes such as combinations of three or more embodiments. For example, the inter-circuit phase-difference estimation technique according to the second embodiment can be applied not only to the first embodiment, but also to the third embodiment.

According to an aspect of the radio-wave arrival-direction estimation device disclosed in the present application, a radio-wave arrival direction can be estimated with high accuracy and in a short time.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio-wave arrival-direction estimation device comprising:
a processor configured to:
determine a plurality of amplitude distributions to be used for signal receptions by respective antennas in a plurality of antenna elements that constitute a plurality of antennas;
switch among the amplitude distributions determined for each of the signal receptions; and
estimate a radio-wave arrival direction of a reception signal based on a correlation coefficient of the reception signal between different antennas and the amplitude distributions switched.

2. The radio-wave arrival-direction estimation device according to claim 1, wherein the processor is further configured to estimate a phase difference of circuits between the antennas based on a radio-wave arrival direction estimated and a correlation coefficient of the reception signal.

3. The radio-wave arrival-direction estimation device according to claim 1, wherein the processor is further configured to set amplitudes of a reception signal received with some of the antenna elements in the plurality of antenna elements to zero to control number of antenna elements to be used.

4. The radio-wave arrival-direction estimation device according to claim 1, wherein the processor is further configured to determine the amplitude distributions in which numbers of antenna elements to be used are same and positions of the antenna elements to be used are different with respect to each of the antennas.

5. The radio-wave arrival-direction estimation device according to claim 1, wherein the processor is further configured to determine number of antenna elements to be used for the signal receptions depending on a demanded gain of the reception signal and a demanded resolution of estimation of the radio-wave arrival direction.

6. The radio-wave arrival-direction estimation device according to claim 1, wherein the processor is further configured to:
group the antennas and determine amplitude distributions in which numbers of antenna elements to be used and positions of the antenna elements to be used are same with respect to antennas in a same group, as amplitude distributions of each group; and
estimate the radio-wave arrival direction of the reception signal with respect to antennas in the same group based on a value obtained by weighted averaging correlation coefficients between antennas.

7. A radio-wave arrival-direction estimation method comprising:
determining a plurality of amplitude distributions to be used for signal receptions by respective antennas in a plurality of antenna elements that constitute the antennas, by a processor;
switching among the determined amplitude distributions for each of the signal receptions, by the processor; and
estimating a radio-wave arrival direction of a reception signal based on a correlation coefficient of the reception signal between different antennas and the amplitude distributions switched, by the processor.
